(19) United States
(12) Patent Application Publication
(10) Pub. No.: US 2002/0052744 A1
(43) Pub. Date: May 2, 2002

(54) Synchronized output speech synthesizer device

(76) Inventor: Chaur-Wen Jih, Taoyuan Hsien (TW)

Correspondence Address: J.C. Patent, Inc., Suite 114, 1340 Reynolds Ave., Irvine, CA, 92614, US

(21) Appl. No.: 09/828,765

(22) Filed: Apr. 9, 2001

(30) Foreign Application Priority Data
Oct. 31, 2000 (TW) 89122874

(51) Int. Cl. G10L 13/00

(52) U.S. Cl. 704/258

(57) ABSTRACT

A synchronized output speech synthesizer having a first memory, a speech synthesizer, a second memory, a multiplexer and a latch device. The speech data of the first memory is read by the speech synthesizer and simultaneously, the latch device through the multiplexer reads the signal data of the second memory. The speech synthesizer and latch device output the voice and status signal in synchrony, while the speaker and the latch device simultaneously output the speech data and the status signals. Therefore, synchronized output of voice and status signals can be carried out, and under conditions of uninterrupted voice synthesis, synchronized status signals can be outputted, so that voice can be continuously and smoothly outputted.

### CROSS-REFERENCE TO RELATED APPLICATION

This application claims the priority benefit of Taiwan application serial no. 89122874, filed Oct. 31, 2000.

### BACKGROUND OF THE INVENTION

1. Field of the Invention

The present invention relates to a speech synthesizer device. More particularly, the present invention relates to a speech synthesizer device with a synchronized status output signal.

2. Description of the Related Art

There are many techniques used in present speech synthesizer, such as a conventional ROM illustrated in a schematic diagram of FIG. 1. In FIG. 1, when a ROM speech synthesizer (not illustrated) needs to read a speech data, the speech data is read from the read only memory (ROM) 10. Take FIG. 1 as an example, when ROM 10 records a starting code, the starting code becomes the starting position of the speech synthesizer (not illustrated) to read speech data, while no end position of the speech data is recorded in ROM 10. Outside the ROM 10, a column of memory 12 is further added on to indicate an end mark 14 serving as the end position of the speech data.

FIG. 2 is a segmented diagram illustrating another conventional ROM. When the speech synthesizer (not illustrated) reads a speech data, the speech data is read from ROM 20. Taking FIG. 2 as an example, when a starting code and a length of the speech data are recorded into ROM 20, the starting code becomes the starting position of the speech synthesizer (not illustrated) to read the speech data. Moreover, a certain length of speech data is read to finish the read action.

However, the use of the speech synthesizer illustrated in FIG. 2 is restricted by a simple state machine, which performs only one task in a period of time. Thus, when the speech region is under a synthesis condition, the state machine is locked, and the speech synthesizer cannot simultaneously carry out the input/output commands.

FIG. 3 is an illustration output status of the conventional speech synthesizer inserted into the speech synthesis. In FIG. 3, the upper wave shows a voice signal 30, and the lower wave shows an output status signal 32. In order to insert output status signal 32 into the voice signal 30, the speech synthesis of the speech synthesizer is temporarily interrupted in the output status signal 32 position, while making a tag at the interrupting point.

Nevertheless, the prior art technique described above has two disadvantages: (1) Once a tag is inserted into the sound wave, meaning the sound wave is replaced by the input/output commands and the voice output is temporarily interrupted. In order to minimize the temporary voice interruption, the cycle time of the input/output commands must be considered, and the number of the input/output commands inserted must be limited. For example, at a sample rate of 8 KHz, when inserted with too many commands, such as seven sample times, there will be 125uS*7 samples and roughly about 800 uS cycle times. (2) As for a smooth voice produced by a flute, when inserted with too many input/output commands, the voice output would be interrupted, thereby degrading the voice output quality

### SUMMARY OF THE INVENTION

Therefore, the invention provides a synchronized output speech synthesizer device, wherein the sync input/output commands can be performed under conditions of uninterrupted voice synthesis. Hence, voice interruption and degradation of voice output do not occur. Furthermore, the invention only incurs a limited cost increase.

As embodied and broadly described herein, the invention provides a synchronized output speech synthesizer device, including a first memory storing a set of speech data. A speech synthesizer receives the speech data stored by the first memory, thereby creating a set of speech signal output. A second memory stores a set of signal data and a latch device receives the signal data stored by the second memory and outputs the status signal. Therein, the speech data of the first memory is read from the speech synthesizer and simultaneously, the signal data of the second memory is read from the latch device. The voice and status signal are then simultaneously outputted through the speech synthesizer and the latch device.

The present invention provides another synchronized output speech synthesizer device, including a first memory storing set of speech data. A speech synthesizer receives the set of speech data stored by the first memory, thereby creating a set of speech signal output. A second memory stores a set of signal data. A multiplexer receives the set of signal data stored in the second memory, and other data from output register or power on reset, and based on selective signals received from a selective input end, outputs the signal data. Also, a latch circuit receives the signal data outputted by the multiplexer and outputs the status signal. Therein, the speech synthesizer reads the status signal outputted by the first memory, and simultaneously, the speech synthesizer reads the signal data outputted by the second memory. Hence, the speech synthesizer and the latch device then simultaneously output voice and the status signal.

The present invention provides a synchronized output speech synthesizer device, wherein speech data and signal data are simultaneously read through a speech synthesizer and a latch device. Thus, this achieves synchronized output of voice and status signals, so that synchronized status signal can be outputted under the uninterrupted voice synthesis condition, and the voice can be outputted smoothly. Furthermore, the invention only incurs a limited cost increase.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention, and, together with the description, serve to explain the principles of the invention. In the drawings,

FIG. 1 is a structural diagram illustrating a conventional ROM;

FIG. 2 is a segmented diagram illustrating another ROM;

FIG. 3 is a diagram illustrating an output status of the conventional speech synthesizer inserted into a speech synthesis;

FIG. 4 is a structural diagram illustrating a ROM according to one preferred embodiment in the present invention;

FIG. 5 is a diagram illustrating an output status inserted into the speech synthesis according to one preferred embodiment in the present invention;

FIG. 6 is a block diagram illustrating a synchronized output speech synthesizer device, according to one preferred embodiment in the present invention; and

FIG. 7 is a block diagram illustrating a synchronized output speech synthesizer device, according to second preferred embodiment of the present invention.

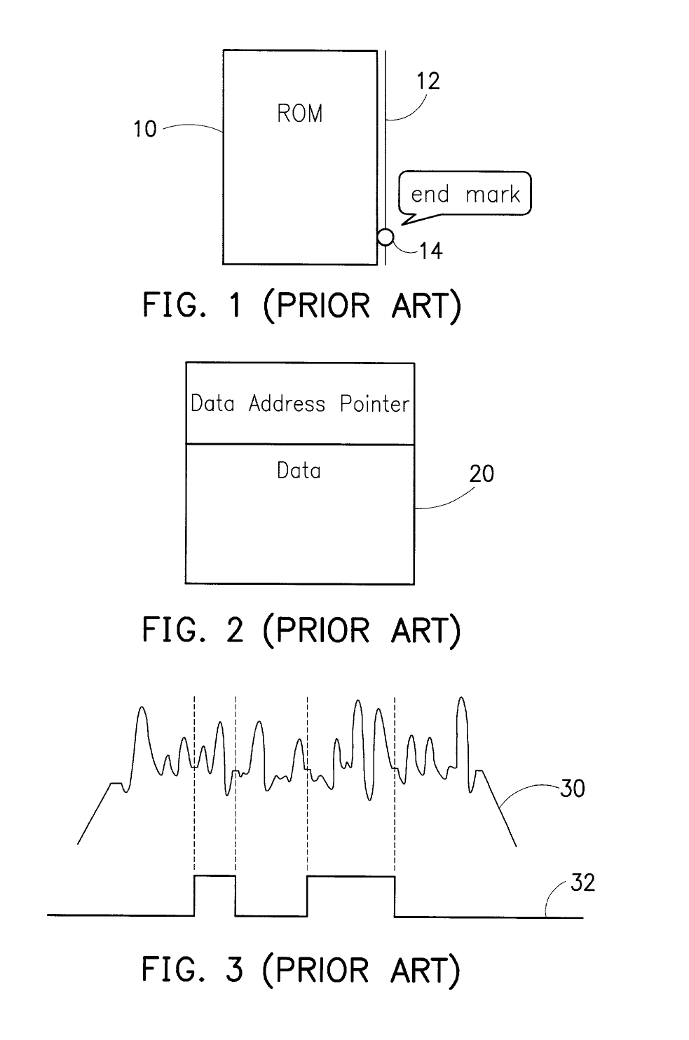

### DESCRIPTION OF THE PREFERRED EMBODIMENTS

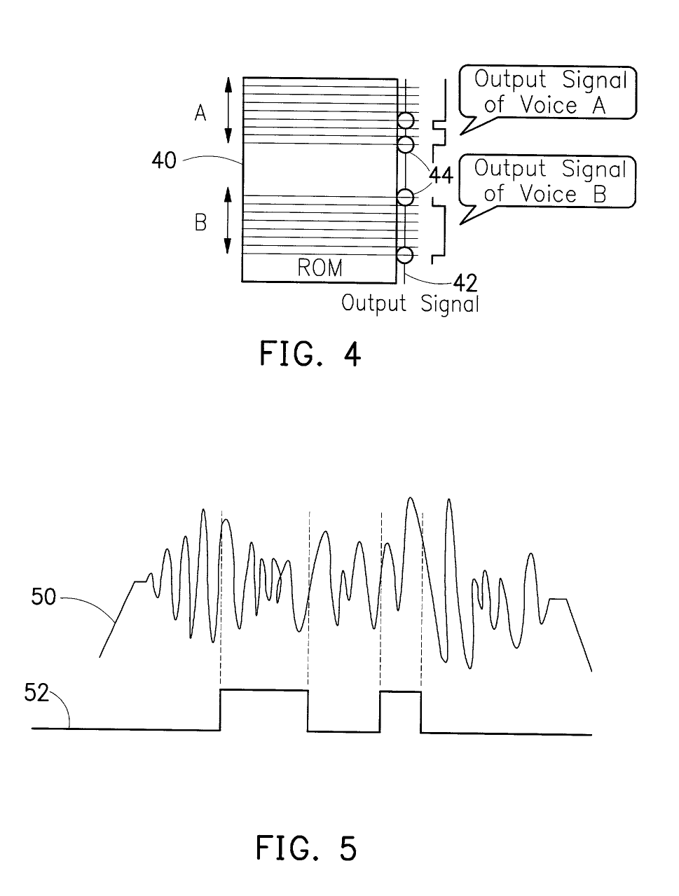

FIG. 4 is a structural diagram illustrating a speech synthesizer ROM in the present invention. According to the present embodiment, the speech synthesizer (not shown) reads the speech data by adopting the structure illustrated in FIG. 2, wherein the speech synthesizer reads the desired speech data from ROM 40. The structure is different from one shown in FIG. 2 in that several columns of memory are further laid out (in the present embodiment, only one column known herein as output signal sync column 42 is used) besides the ROM 40 for storing the signal data. The ROM area increased by the output signal sync column 42 of the extra layout is merely one one-thousandths of ROM 40, so the cost will not increase significantly. When the speech data from first column of each row of ROM 40 is read, the signal data of the output signal sync column 42 is simultaneously read. In FIG. 4, if the output signal sync column 42 marker is a circle 44, this indicates “0” (low position signal); if the marker is not a circle 44, this indicates “1” (high position signal).

The present embodiment uses an example to describe the sync column formation, and the completion procedure of the sync column:

1. Use waveform editing tools to edit the speech data of the ROM, a tag is inserted into the voice source and combined with the output status to produce a output signal.

2. The PCM waveform is saved into a file with the data for the sync column.

3. The said file and the user's program are compiled or assembled into an object file, wherein the object file comprises a combination of the speech data and the sync column data.

4. The appropriate data is filled into the ROM and sync column according to physical layout of the ROM.

FIG. 5 is a diagram illustrating an output status inserted into the speech synthesis according to the preferred embodiment of the present invention. In FIG. 5, the upper wave is a voice signal 50, and the lower wave is an output status signal 52. It can be seen in FIG. 5 that, when the output status signal 52 changes status, the voice signal 50 is not interrupted at all. Therefore, the voice can be continuously and smoothly outputted in synchrony with the output status signal 52.

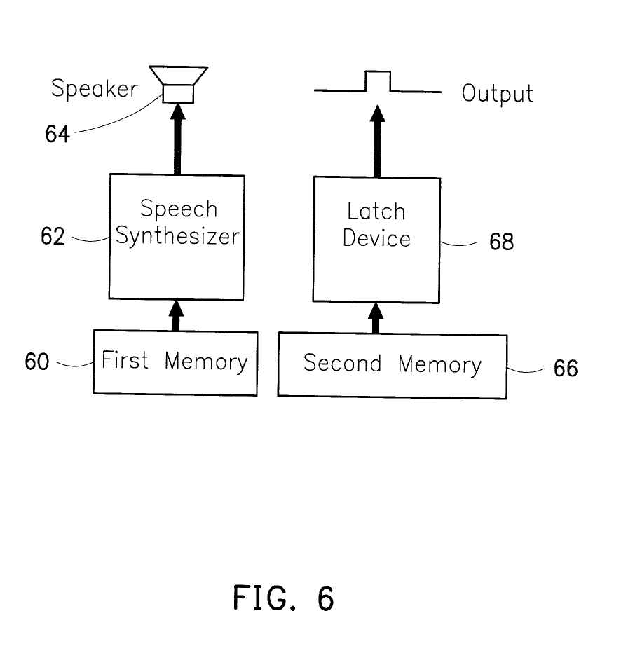

FIG. 6 is a block diagram illustrating a synchronized output speech synthesizer device according to one preferred embodiment in the present invention. In FIG. 6, the first memory 60 uses the speech compilation software to store speech data. The speech synthesizer 62 receives the speech data stored by the first memory 60, thereby sending the speech signal output to the speaker 64. The speaker 64 receives the speech signal output by the speech synthesizer 62 and plays the sound. A second memory 66 uses a speech editing software to store signal data. The latch device 68 receives the signal data stored by the second memory 66 and outputs the status signal. Therein, the speech synthesizer 62 reads the speech data of the first memory 60, and simultaneously, the latch device 68 reads the signal data of the second memory 66. Hence, the speaker 64 and the latch device 68 output voice and status signal in synchrony.

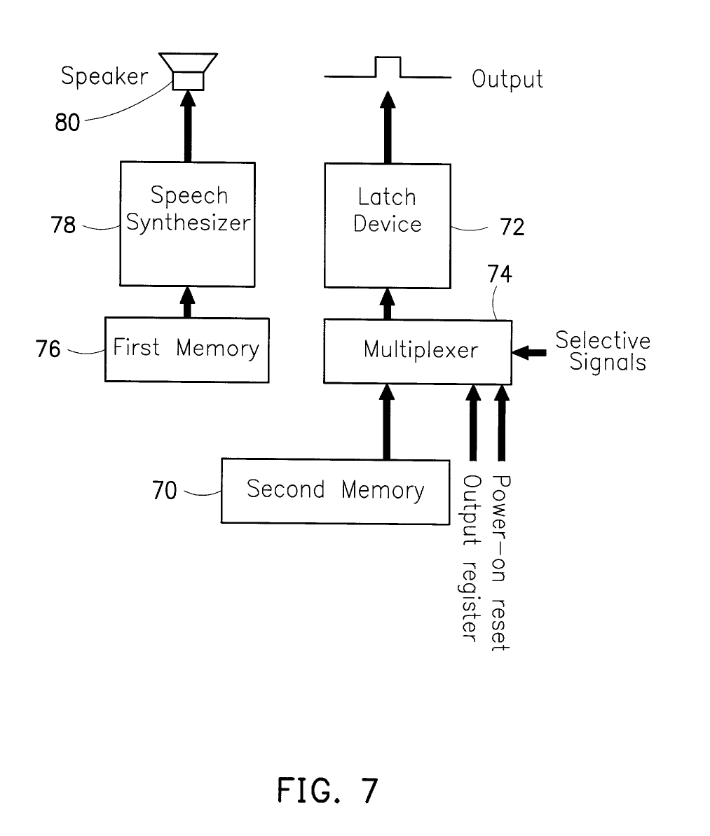

FIG. 7 is a block diagram illustrating a synchronized output speech synthesizer device according to second preferred embodiment of the present invention. In contrast to FIG. 6, there is a multiplexer 74 between the second memory 70 and the latch device 72. Besides receiving the signal data of the second memory 70, the multiplexer 74 also receives output register data manipulated by instructions and power-on reset signals. The multiplexer 74 is controlled through selective signals to select the signal to be output from the output end of the multiplexer 74 to the latch device 72. Therein, the speech synthesizer 78 reads the speech data of the first memory 76, and simultaneously, the signal data of the second memory 70 is read by the multiplexer 74 through the latch device 72. Thus, the speaker 80 and the latch device 72 output voice and status signal in synchrony.

The present invention is advantageous for providing a synchronized output speech synthesizer device, wherein speech data and signal data are simultaneously read through a speech synthesizer and a latch device. Thus, this achieves synchronized output of voice and status signal, so that synchronized status signal can be outputted under the uninterrupted voice synthesis condition, and the voice can be outputted smoothly. Furthermore, the invention only incurs a limited cost increase.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronized output speech synthesizer, comprising:
a first memory for storing speech data;
a speech synchronizer for receiving the speech data stored by the first memory, thereby creating a speech signal output;
a second memory for storing signal data; and
a latch device for receiving the signal data stored by the second memory and thereby outputting a status signal;
wherein the speech synthesizer reading speech data of the first memory while, the latch device simultaneously reading the signal data of the second memory, and the speech synthesizer and the latch device outputting the voice and status signals in synchrony.

2. The synchronized output speech synthesizer device as defined in claim 1, further comprises a speaker for receiving the speech signal outputted by the speech synchronizer and playing the voice.

3. A synchronized output speech synthesizer device, comprising:
a first memory for storing speech data;
a speech synthesizer for receiving the speech data stored by the first memory, thereby creating a speech signal output;
a second memory for storing signal data; and
a multiplexer for receiving the signal data stored by the second memory and outputting a speech signal based on a selective signal received by a selective input ends; and
a latch device circuit for receiving the signal data output by the multiplexer, and outputting a status signal;
wherein the speech synthesizer reading the speech data of the first memory, while the multiplexer simultaneously reading the signal data of the second memory through the latch device, and speech synthesizer and the latch device outputting the voice and status signals in synchrony.

4. The synchronized output speech synthesizer device as defined in claim 3, further comprises a speaker for receiving the speech signal outputted by the speech synchronizer and playing the voice.

5. The synchronized output speech synthesizer device as defined in claim 4, wherein the material received by the multiplexer includes the signal data, an output register data and a power-on reset signal.
